(19) United States
(12) Patent Application Publication
(10) Pub. No.: US 2026/0264171 A1
(43) Pub. Date: Sep. 10, 2026

(54) IDENTIFICATION AND CORRECTION OF WELD PATHS USING OPTICAL COHERENCE TOMOGRAPHY

(71) Applicant: IPG PHOTONICS CORPORATION, Marlborough, MA (US)

(72) Inventors: Nicholas D. SCHWENGER, KINGSTON (CA); Kodie D. BECKER, KINGSTON (CA); Paul J.L. WEBSTER, KINGSTON (CA)

(73) Assignee: IPG PHOTONICS CORPORATION, Marlborough, MA (US)

(21) Appl. No.: 19/520,577

(22) PCT Filed: May 17, 2024
(86) PCT No.: PCT/US2024/029883

§ 371 Date: Mar. 18, 2026

Related U.S. Application Data
(60) Provisional application No. 63/467,036, filed on May 17, 2023.

(51) Int. Cl. B23K 26/24; B23K 26/03; B23K 26/082; B23K 101/36; G01B 9/02091; G05B 13/02; H01M 50/107

(52) U.S. Cl. CPC B23K 26/24; B23K 26/032; B23K 26/082; G01B 9/02091; G05B 13/0265; B23K 2101/36; H01M 50/107

(57) ABSTRACT

A method and system for laser welding a workpiece. The system may include a laser source emitting processing laser radiation, an OCT system that includes an imaging light source emitting imaging light and is configured to generate an interferometric output, a laser head configured to direct processing laser radiation and a beam of the imaging light onto the workpiece, at least one scanner configured to direct the beam of imaging light along at least one measurement weld path on the workpiece, and at least one controller configured to: receive data corresponding to a reference weld path on the workpiece, generate a corrected weld path based at least in part on a comparison between the interferometric output of the at least one measurement weld path and the reference weld path, and control the laser head such that the processing laser radiation is directed along the corrected weld path on the workpiece.

### RELATED APPLICATIONS

The present application claims priority to U.S. Provisional Application Ser. No. 63/467,036, titled “IDENTIFICATION AND CORRECTION OF WELD PATHS USING OPTICAL COHERENCE TOMOGRAPHY,” filed on May 17, 2023, the content of which is hereby incorporated by reference in its entirety.

### BACKGROUND

### Technical Field

The technical field relates generally to the use of optical coherence tomography (OCT) in laser welding applications, and more specifically to the use of OCT to adjust weld paths in laser welding applications.

### Background Discussion

Manufacturing batteries for electric vehicles presents many unique challenges. To be safe and economically viable, the battery manufacturing process must achieve high metrics for speed and quality. Quality metrics may include precise weld positioning, weld depth, weld strength, and weld process consistency. Laser welding has emerged as a technology that is capable of addressing some of these challenges, but the success of laser welding of batteries is contingent on the accuracy and precision of the weld path.

Issues with weld path accuracy may arise even when the raw components of a battery are manufactured to within their specified tolerances (through forming techniques such as stamping and pressing). Weld path accuracy is further challenged by the additional variability introduced by part-fixturing, and inconsistency in system movement and positioning (such as linear stages and robotic arms). The result is a workpiece shape that is sufficiently irregular that a weld path positioned without some feedback control would result in a weld of insufficient quality. Poorly positioned welds can result in immediate failure, or lead to sudden failure after some time. In either case, the failure of a battery weld can be catastrophic, compromising the battery assembly system if failures arise during assembly, and putting the public in jeopardy if a poor weld is able to make it into a finished product.

A number of machine vision technologies based on cameras have been employed to improve weld path accuracies and sometimes measure quality. However, these approaches have a number of deficiencies. One is that the contrast developed in a camera-based vision solution is very dependent on lighting, which makes these approaches difficult to engineer. Camera-based solutions can be influenced by outside sources of light, which may not be uniform throughout the entire field of view of a welding scanner. This causes the field of view of the scanner, and subsequently its productivity to be limited. In some cases, elements of the fixture or workpiece itself may create shadows that make camera-based vision contrast difficult. Camera-based methods are also often not able to measure during welding (due to blurring of their field of view and/or overexposure due to light created by the weld process) or capture critical quality aspects such as penetration.

Therefore, a method to rapidly correct for weld positioning and create highly precise weld paths for each individual battery cell, prior to welding, is valuable to battery manufacturers. This issue exists for any battery or cell that will be laser welded, including but not limited to, 46XX (such as 4680) cells, 21XXX (such as 21700) cells, and prismatic batteries.

Beyond weld quality, any misalignment of the weld on the part may make it difficult for subsequent quality assurance (QA) related measurements to be taken. This could lead to difficulties in tracking and flagging poor welds, leading to compromised battery cells that make their way into later stages of production, costing a significant amount of waste if and when the defect is finally identified.

Conventional methods for defining and correcting weld paths include the use of optical or camera-based systems to detect the edge, seam, or geometry of an object. Such systems are highly dependent on the quality and consistency of a component's illumination, material reflectivity, and fit-up. Downsides to these types of systems is that they can increase the cost, mechanical complexity, and integration complexity of a system because of the additional equipment requirements. Further, they do not enable direct measurement of the weld depth and other weld features, such as the seam and part fit-up ahead of the weld, and solidified weld bead behind the weld.

### SUMMARY

Aspects and embodiments are directed to a method and system for laser welding a workpiece. In accordance with certain embodiments, a laser welding system for welding a workpiece is disclosed. In accordance with an exemplary embodiments there is provided a laser welding system for welding a workpiece that includes a laser source configured to emit processing laser radiation, an optical coherence tomography (OCT) system that includes an imaging light source configured to emit imaging light, the OCT system configured to receive reflected imaging light from the workpiece and generate an interferometric output based at least in part on the reflected imaging light, a laser head configured to direct processing laser radiation and a beam of the imaging light onto the workpiece, at least one scanner configured to direct the beam of the imaging light along at least one measurement weld path on the workpiece, the at least one measurement weld path based at least in part on a reference weld path on the workpiece, and at least one controller configured to: receive data corresponding to the reference weld path on the workpiece, generate a corrected weld path based at least in part on a comparison between the interferometric output of the at least one measurement weld path and the reference weld path, and control the laser head such that the processing laser radiation is directed along the corrected weld path on the workpiece.

In one example, the interferometric output of the at least one measurement weld path is used by the at least one controller to generate multi-dimensional geometric data that is used to generate the corrected weld path.

In one example, the at least one controller is further configured to apply a curve fitting algorithm to generate the corrected weld path.

In one example, the OCT system and a scanner of the at least one scanner are configured to obtain transverse measurements along the at least one measurement weld path.

In one example, the reference weld path, measurement weld path, and corrected weld path are elliptical paths.

In one example, the workpiece is a battery cell.

In one example, the at least one controller controls the at least one scanner such that the beam of imaging light is directed along the corrected weld path at the same time as the processing laser radiation is directed along the corrected weld path, and the at least one controller is configured to calculate weld depth measurements based on an interferometric output generated at least in part from the beam of imaging light being directed along the corrected weld path.

In one example, the at least one scanner includes a scanner configured to direct the processing laser radiation along the corrected weld path on the workpiece.

In one example, the at least one controller controls the at least one scanner such that the beam of imaging light is directed along a post-weld scan path along the corrected weld path after the processing laser radiation is directed along the corrected weld path and the at least one controller is configured to calculate at least one post-weld measurement based on an interferometric output generated at least in part from the beam of imaging light being directed along the post-weld scan path.

In one example, the controller is further configured to: acquire a plurality of corrected weld paths, and process the plurality of corrected weld paths using one or more trained machine learning models to predict the corrected weld path. In a further example, the one or more trained machine learning models are further trained using the plurality of corrected weld paths.

In one example, the laser head is configured to be stationary and the workpiece is configured to be in motion relative to the laser head during at least a portion of a time period where at least one of the processing laser radiation and the beam of imaging light are directed onto the workpiece.

In accordance with another exemplary embodiment, there is provided a method for welding a workpiece that includes receiving a reference weld path for the workpiece, directing a beam of imaging light along at least one measurement weld path on the workpiece, the at least one measurement weld path based at least in part on the reference weld path, determining interferometric output based at least in part on reflected imaging light from the workpiece along the at least one measurement weld path, generating a corrected weld path based at least in part on a comparison between the interferometric output of the at least one measurement weld path and the reference weld path, and directing processing laser radiation along the corrected weld path on the workpiece.

In one example, the method further includes using the interferometric output of the at least one measurement weld path to generate multi-dimensional geometric data that is used to generate the corrected weld path.

In one example, generating the corrected weld path further comprises applying a curve fitting algorithm.

In one example, the method further includes obtaining transverse measurements with the beam of imaging light along the at least one measurement weld path.

In one example, the method further includes directing the beam of imaging light along the corrected weld path while the processing laser radiation is directed along the corrected weld path, determining interferometric output based at least in part on reflected imaging light from the workpiece along the corrected weld path, and calculating weld depth measurements based on the interferometric output generated at least in part from the beam of imaging light being directed along the corrected weld path.

In one example, the method further includes directing the beam of imaging light along a post-weld scan path after the processing laser radiation is directed along the corrected weld path, determining interferometric output based at least in part on reflected imaging light from the workpiece along the post-weld scan path, and calculating at least one post-weld measurement based on the interferometric output generated at least in part from the beam of imaging light being directed along the post-weld scan path.

In one example, the workpiece is a battery cell and the method further includes comparing geometric coordinate values of the corrected weld path to a target threshold, and in response to a determination that the geometric coordinate values fall within the target threshold, accepting the battery cell, or in response to a determination that the geometric coordinate values do not fall within the target threshold, rejecting the battery cell.

In one example, the method further includes acquiring a plurality of corrected weld paths, and processing by a computer processor the plurality of corrected weld paths using one or more trained machine learning models to predict the corrected weld path. In a further example, the method further includes training the one or more trained machine learning models using the plurality of corrected weld paths.

Still other aspects, embodiments, and advantages of these example aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Embodiments disclosed herein may be combined with other embodiments, and references to “an embodiment,” “an example,” “some embodiments,” “some examples,” “an alternate embodiment,” “various embodiments,” “one embodiment,” “at least one embodiment,” “this and other embodiments,” “certain embodiments,” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a block diagram of one example of a laser welding system that integrates the use of OCT in accordance with one or more aspects of the invention;

FIG. 2 is a schematic illustration of one example of OCT being applied to a workpiece in accordance with one or more aspects of the invention;

FIG. 3 is one example of an output of the integrated use of OCT with a laser welding system in accordance with one or more aspects of the invention;

FIG. 4 shows one example of OCT interferometric result data obtained prior to any corrections being applied;

FIG. 5 shows one example of OCT interferometric result data obtained after corrections have been applied in accordance with aspects of the invention;

FIG. 6 shows one example of OCT interferometric result data showing three (3) pinholes in a finished weld (left) and an overhead image of the detected pinholes (right) in accordance with aspects of the invention;

FIG. 7 shown one example of OCT interferometric result data from a weld through the cap material into a material below the cap in accordance with aspects of the invention; and

FIG. 8 is one example of a spiral scan used to perform post-weld analysis in accordance with aspects of the invention.

### DETAILED DESCRIPTION

One of the many issues to consider when addressing the problems discussed above with regard to battery welding is how such a solution can be implemented economically into a laser welding system to solve multiple problems at once. Optical coherence tomography (OCT) is a technology that is used in combination with laser welding to measure, in real time, many features, such as the weld depth of a laser weld. This allows for the immediate flagging of potential weld defects, right at the station where the weld is performed, alleviating the issue of defective parts continuing through the production line. Disclosed herein is a laser welding system that implements the economic benefits of OCT technology and addresses the aforementioned technical issues with regard to weld path accuracy and positioning.

Various embodiments presented herein involve a dynamic correction of the weld path for battery cells based on measurements taken by an OCT system. The solution targets, but is not limited to, the dynamic correction of welds involving elliptical or circular shapes, such as cap-to-can, collector-to-flag, and cap-to-collector welding of 46XX cells (such as the 4680). In at least one embodiment, the approach involves a scanning of the fixtured component geometry in order to accurately align the weld processing path with the fixtured component before, during, or after the weld. Although aspects discussed herein are primarily focused on components with seams, edges or features which have a substantially circular or elliptical geometry (e.g., the geometries which are present in cylindrical 46XX cells), it is to be appreciated that other geometries are also within the scope of this disclosure.

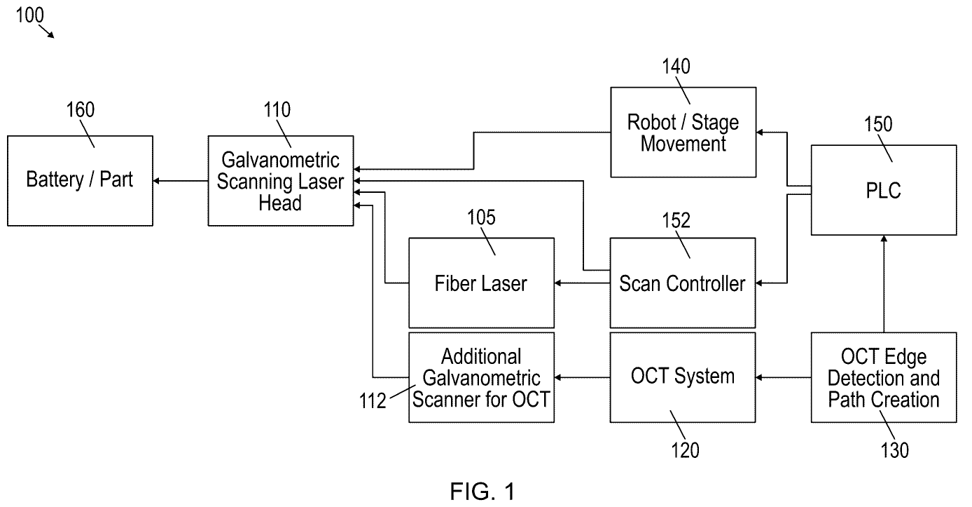

In accordance with one embodiment, an Optical Coherence Tomography (OCT) system is integrated into an automated laser welding system, a non-limiting example of which is generally indicated at 100 in FIG. 1, to measure the feature (e.g. elliptical seam) which is used for weld path correction. Laser welding system 100 may comprise a fiber laser 105 (also referred to herein as a laser source), a laser head 110 (that may be equipped with a scanner), OCT system 120, scanner 112 associated with OCT system 120, and at least one controller (e.g., controller 150, and scan controller 152 for laser head 110, the latter of which in some instances may be implemented by controller 150). In addition, OCT edge detection and path creation capability 130 is also included, as discussed in further detail below, which in some instances is implemented via controller 150 in combination with OCT system 120.

In some embodiments, system 100 also includes workpiece and/or laser head movement capability 140.

In accordance with at least one embodiment, laser welding system 100 is implemented for cap-to-can, collector-to-flag, and cap-to-collector welding of 46XX cells (such as the 4680) welding applications. The OCT system 120 is used to measure the cell (weld path) using the imaging beam of the OCT system 120 prior to application of the processing laser beam.

The fiber laser 105 may be an IR, UV, blue, or green fiber laser emitting single mode (SM) or multimode (MM) processing laser radiation. The laser radiation may be pulsed, continuous wave (CW), or quasi-continuous wave (QCW). The processing laser radiation is used to perform the actual welding operation. In some embodiments, the fiber laser is configured with more than one waveguiding structure. For instance, in accordance with at least one embodiment, the fiber laser is or is configured as an IPG Photonics YLS-AMB (Adjustable Mode Beam) laser (IPG Photonics Corp., Marlborough, MA, USA), which has the ability to output different beam profiles, such as a central beam, a ring beam, or both. Although fiber lasers are discussed herein, other types of lasers may also be within the scope of this disclosure, including CO₂ lasers and solid state lasers (e.g., Nd: YAG).

The OCT system 120 includes an imaging light source that is configured to emit imaging light. The OCT system 120 is configured to receive reflected imaging light from the workpiece 160 and generate an interferometric output based at least in part on the reflected imaging light. As will be understood by those of skill in the art, the reflected imaging light from the workpiece corresponds with an optical path referred to as the sample arm. A reference optical path (created from reflected imaging light from a reference source such as a mirror, also referred to as a reference arm) is also a component of OCT system 120 (not explicitly shown in the figures). The interference between these two optical paths (the effects of optical path length differences) is used to generate the interferometric output, which in turn can be used in determining a depth measurement.

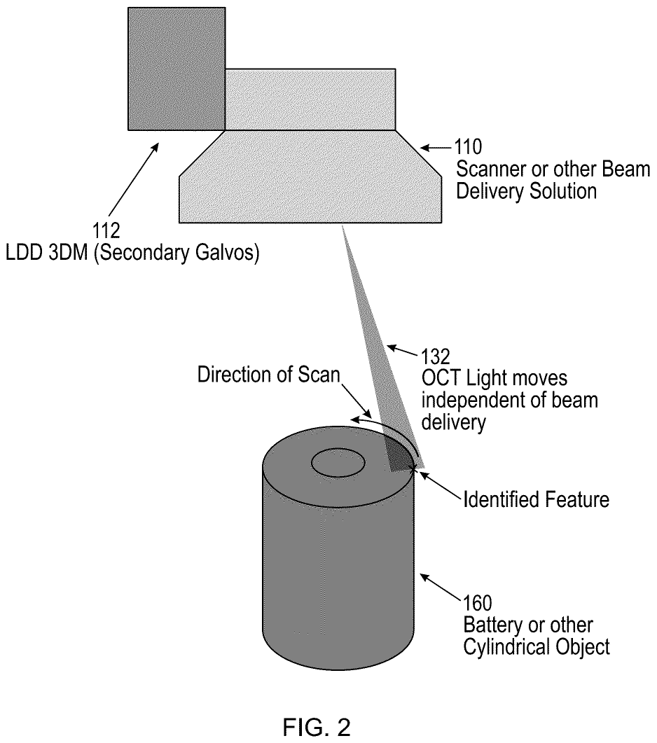

The laser head 110 is configured with optical components to direct one or both of the processing beam emitted from the fiber laser 105 and the imaging beam 132 (e.g., see FIG. 2) from the OCT system 120 onto the workpiece 160. As indicated in FIG. 1, laser head 110 may be configured with scanning ability (e.g., galvanometric scanners) to scan one or both of the processing laser beam and the imaging beam 132. For instance, the scanning capability of the laser head 110 may be configured to direct the processing beam and/or imaging beam along a path on the workpiece 160. In some embodiments this path is elliptical. Here, “elliptical” includes “circular” which is one type of “elliptical.” In some instances a robot/stage movement 140 capability (i.e., x, y, and/or z movement) is implemented to assist with movement of one or both of these beams along the path on the workpiece (robot/stage movement 140 may also be used with scanner 112 discussed below). Non-limiting examples of suitable beam delivery heads include laser heads from IPG Photonics, including IPG's 2D High Power Scanner (HPS) equipped with an air knife. Other beam delivery systems are also within the scope of this disclosure.

In accordance with at least one embodiment, scanner 112 is configured to direct the imaging beam 132 of the OCT system 120 onto the workpiece 160. As indicated in FIG. 1, scanner 112 may be configured as a galvanometric scanner, as known in the art. Non-limiting examples of a suitable OCT system 120 and scanner 112 for scanning the imaging beam are available from IPG Photonics, including the LDD-700 inline weld monitoring system. Such a system may be optomechanically integrated and coupled to the scanning head 110 by techniques described in IPG's product documentation and U.S. Pat. Nos. 9,757,817, 10,413,995, 10,654,126, 11,426,816, which are owned by Applicant and incorporated by reference in their entirety.

In some embodiments, at least one scanner is configured to direct the imaging beam of the OCT system 120 along at least one measurement weld path on the workpiece. For instance, at least one of the scanner of laser head 110 and scanner 112 may direct the imaging beam along the at least one measurement weld path. In some embodiments, the scanning ability of laser head 110 may be used to direct the imaging beam along a reference optical path (described in further detail below) and scanner 112 may be used to obtain transverse measurements as the scan proceeds. In other embodiments, scanner 112 is configured to do the scanning as well as the transverse measurements.

The controller 150 (also referred to herein as a processor or computer processor as known in the art) is configured as a computing device, as known in the art, and in some embodiments is a programmable logic controller (PLC) as known in the art, with non-limiting examples suitable for use with the teachings of this disclosure available from Allen-Bradley® or Siemens®. It is to be appreciated that control may also be executed via scan controller 152 for laser head 110, and OCT system 120, which may also have computing and controlling capabilities.

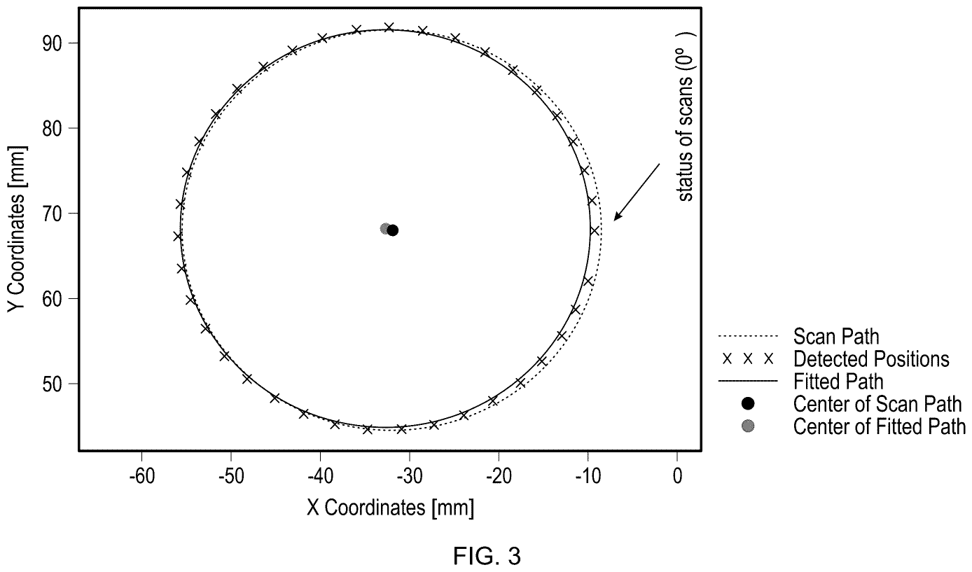

According to one embodiment, a reference weld path is obtained by one or more components of the system. The reference weld path can be considered as the “expected” or “nominal” geometry of the component (workpiece 160) to be welded. An example of such a reference weld path is shown in FIG. 3 by the dotted line. This reference weld path can be obtained, for example, from a weld specification (that outlines a “perfect” component in a “perfect” fixture) that is either input into or computed by the system. The reference weld path may be defined in engineering drawings or design and can be considered as a starting point for the corrective measurements and to which corrections are applied. A user may input the reference weld path into the system (e.g., into controller 150).

As mentioned previously, at least one scanner (e.g., that of laser head 110 and/or scanner 112) is configured to direct the imaging beam 132 of the OCT system 120 along at least one measurement weld path on the workpiece 160. The measurement weld path is based at least in part on the reference weld path. One non-limiting example of such a configuration is shown in FIG. 2, where the galvo mirrors of scanner 112 allow for imaging beam 132 to move independently of the scanning capability of laser head 110. FIG. 3 shows one example where each “X” represents a measurement along the at least one measurement weld path. Therefore, in some embodiments, multiple measurements are obtained via the imaging beam 132 along the measurement weld path. In some embodiments, multiple transverse scans (measurement weld path(s)) along the edge of the battery are done using scanner 112 to measure the edge geometry and build up a representation of the geometry of the component (workpiece 160).

One or more components of system 100 (e.g., controller 150, OCT system 120) are configured to measure the positioning/offset of the outer and/or inner edge of the battery can or the seam of the cell, which are non-limiting examples of weld paths, relative to the reference weld path. For instance, interferometric output from the at least one measurement weld path can be compared to the reference weld path. In accordance with various aspects it is beneficial to consider and compensate for the motion and associated aberrations of the primary scanner (in laser head 110) during each transverse scan in order to obtain the best quality image data. In some instances the interferometric output from the at least one measurement weld path can be used to generate multi-dimensional geometric data. In some embodiments, the geometric data can be used to generate a geometric representation, such as a three-dimensional (3D) contrast image. In accordance with some embodiments, the multi-dimensional geometric data can be used, at least in part, to generate the corrected weld path (discussed in further detail below). The measurements and/or the geometric representation may be determined by or communicated to controller 150 or other controller such as the controller for the scanning laser head 110. As will be appreciated, communication between components of system 100 can be done through analog or digital communication such as through transmission control protocol (TCP) or other communication protocols known to those of skill in the art.

In some embodiments, a corrected weld path is generated based at least in part on the comparison between the interferometric output of the at least one measurement weld path and the reference weld path. The corrected weld path represents the actual welding path the processing laser beam will follow on the workpiece 160 during the welding process. Control of the processing laser beam to follow the corrected weld path can be performed by the scanner of laser head 110. For example, galvanometric (galvo) scanner of laser head 110 may scan the processing beam around the top edge or seam of the battery cell along the corrected weld path. Control of laser head 110 may also be performed by controller 150.

The corrected weld path may also be referred to as a fitted path. An example of a corrected weld path is shown in FIG. 3 as a solid line and is elliptical shape in this particular example. In this example, the fitted path is an ellipse based on the detected edge positions (i.e., measurements of the measurement weld path) and is offset inwards as desired. In accordance with at least one embodiment, a curve fitting algorithm is used to generate the corrected weld path. For instance, according to some embodiments, the measured points of the at least one measurement weld path may be used to track, identify, locate, and evaluate (TILE) the position offset and rotation of the cell relative to nominal shape and positioning using a tracking and/or fitting algorithm, such as direct linear least squares method. In certain embodiments, algorithms that work with any number of points are implemented. The calculations and path fitting can be done by a controller included with OCT system 120, controller 150, a downstream controller, or some other external controller. In practice, a cell(s) where the fitted geometry (corrected weld path) (e.g., ellipse) is outside of tolerances can be identified and rejected and/or corrected before further processing is performed. Welds along the battery cap-can seam using the fitted ellipse as the corrected weld path can then be performed, and/or other welds with paths which have been corrected based on the detected geometry can then be performed (such as circular, oval, or spiral geometry welds which are toleranced/specified with reference to the tracked/fitted part geometry). As a practical example, in instances where the workpiece is a battery cell, the geometric coordinate values of the corrected weld path (e.g., X, Y coordinates) can be compared to a target threshold (e.g., by the controller 150) and in response to a determination that the geometric coordinate values fall within the target threshold, the battery cell is accepted, or in response to a determination that the geometric coordinate values do not fall within the target threshold, the battery cell is rejected. This concept can be expanded to include an “in situ” measurement that is performed just prior to the process laser radiation performing the weld (i.e., a “second” set of measurements obtained by the OCT imaging beam) to identify any process shifts (e.g., the workpiece has shifted) that have occurred since the “first” set of measurements obtained by the OCT imaging beam (performed long the measurement weld path that is based at least in part on the reference weld path). As with the aforementioned control scheme, geometric coordinate values obtained from this “second” scan can be compared to a target threshold and workpieces can be rejected or accepted based on the comparison.

According to at least one embodiment, the OCT system can also be used to acquire weld depth measurements during welding along the corrected path. For instance, the imaging beam can be directed along the corrected weld path at the same time as the processing laser beam is directed along the corrected weld path and interferogram output obtained therefrom can be used to calculate weld depth measurements. In some embodiments, after or while the welding is completed, the OCT system can be used for post-scans along the corrected weld path (such as post scans in a circular, oval, or spiral geometry, these are just some non-limiting examples of post-weld scan paths) to be used to inspect for porosity, pitting, pin-holing, and to detect other surface imperfections. In this way, the path correction aids not only making the weld, but evaluating it as well. The post-weld scan path can be any geometry (including directly along the corrected weld path) on the workpiece following the progression of the process beam's laser radiation. Thus, according to at least one embodiment, the beam of imaging light is directed along a post-weld scan path along the corrected weld path after the processing laser radiation is directed along the corrected weld path and the controller is configured to calculate at least one post-weld measurement based on an interferometric output generated at least in part from the beam of imaging light being directed along the post-weld scan path.

In accordance with certain embodiments the disclosed system and method may be configured to work with other configurations. For example, the technique may be applied to a system where the laser is delivered through a fixed or wobble optic that moves via a robot stage or arm. The OCT beam may be moved independently of the processing laser since it is controlled by its own set of galvo mirrors. After detecting the edges of the part, the corrected geometry (corrected weld path) can be applied to the control of the robot to guide the entire fixed or wobble optic along the corrected weld path.

In some embodiments, the OCT imaging beam may be directed to scan geometrical elements of material geometries proximal to one that is currently being welded in order to save time. For instance, while the laser is welding a pair of copper hairpins, the motion of the primary scanner may be compensated/stabilized by the motion of the OCT scanner and an additional displacement added by same such that the OCT system and/or a camera could be used to measure a neighboring pair of hairpins.

In some embodiments the system is configured to work with any of the industry standard batteries, such as the 46XX, 21XXX, and prismatic cells, or any other object requiring a precise laser weld alignment. Some non-limiting examples of these include heat exchanger tubes, filters, fittings, connectors, busbars, or electrical terminations. For some objects it may be preferable to use the galvo scanner 112 to scan to pre-determined locations to find other features such as edges, gaps, or fiducials, and then create a weld path accordingly. The technique does not need to be applied to one component at a time, but may be applied to multiple cells and geometries in parallel or in series all placed within the scanner or robot's field of view or working area, where all the paths are calculated, followed by performing the welds.

In some embodiments, the OCT system is further employed to determine the distance between a desired focal plane and the workpiece and inform the beam delivery system of these variations in this direction as well.

In accordance with at least one embodiment, the OCT system is configured with dynamic focus control. According to some embodiments, the focal position of the imaging beam may be actuated axially (and independently of the processing laser beam) to keep the focus of the imaging system near the surface of the workpiece. One non-limiting example of such a configuration is described in U.S. patent application Ser. No. 17/897,905 (published as US 2023/0036545), which is owned by Applicant and is hereby incorporated by reference in its entirety. In some embodiments, the OCT system (e.g., via generated interferometric data) may be used to improve the focus of the imaging beam and/or the focus of the processing laser beam.

In accordance with at least one embodiment, the beam delivery system for the processing laser beam is configured with dynamic focus control. For instance, according to some embodiments, the focal position of the processing laser beam may be actuated axially (and independently of the imaging beam), e.g., to keep the focus of the processing laser beam near the surface of a flat workpiece as the processing beam transits the field of view of a scanner (included in the beam delivery system). In a further embodiment, the OCT system may be configured to determine the axial position of a workpiece within a field of view (of at least one scanner) and provide feedback to the dynamic focus control of the beam delivery system for the process laser beam and/or provide feedback to the dynamic focus control of the imaging beam of the OCT system.

According to at least one embodiment, the system is configured to provide adjustment (automatic or otherwise) of the imaging beam's position relative to the processing laser beam, to compensate for motion/misalignment. For example, such adjustment may be carried out automatically, to adjust the imaging beam for changes in the velocity of the processing beam, and/or changes in the direction of the processing beam, and/or changes in the relative velocity between the beam delivery system and the workpiece, and/or changes in the process beam velocity and/or the velocity of the process beam's focus relative to the workpiece. For instance, in some embodiments, the imaging beam scanner controls or otherwise directs the imaging beam based on a velocity of the process beam. In some embodiments the imaging beam may be adjusted to compensate for flexing and dynamic misalignment in the processing beam head and/or motion system. In some embodiments, the scanning device is used to adjust the imaging beam's position to compensate for flexing and any dynamic misalignment of the head, the optics contained therein, and any motion system, such as, e.g., a robot or gantry motor that is utilized to effect the material modification process. In some embodiments, the OCT scanner is used to compensate for beam misalignments caused by actuating a focus axis of the process beam, the imaging beam, or both.

In some embodiments of the invention, the OCT system is able to detect variations in the edge quality and/or gap between mating pieces in the weld. These measurements may be further used to inform the process parameters. Look up tables, and/or parameterized relationships between a selection of gap, laser power, speed, wobble amplitude, wobble frequency focal position may be employed to adapt the process to these detected variations.

The measurement and welding of the battery cell workpieces by the laser welding system can be configured several different ways. In some configurations, the battery cell workpiece 160 moves along a conveyer and the laser head 110 starts at location X with the arrival of a cell workpiece at location X, and then moves along the conveyer with the workpiece 160 until the measurement and welding processes are complete, at which point the laser head 110 moves back to location X and starts measuring and welding a new workpiece on the conveyer. In other configurations, the laser head 110 remains stationary/fixed at point X and the conveyer moves the battery cell workpiece 160 to point X and the workpiece remains at X until the measurement and welding processes are complete, at which point the workpiece move along the conveyer and a new workpiece moves into point X. In other words, according to some embodiments the laser head is configured to be stationary and the workpiece is configured to be moved to a position under the laser head such that the processing laser radiation and the beam of imaging light are directed onto the workpiece. This latter configuration may be advantageous because the process beam may be engaged in actual welding activity for greater amounts of time since the laser head does not have to move back and forth. In addition, having the laser head be in motion while measuring a workpiece in motion increases the chances of misalignments between the head and workpiece, as well other variabilities. In still other configurations, the laser head 110 remains stationary at point X (having a field of view Y) and the conveyer moves the battery cell workpiece 160 in a continuous manner which passes through the field of view Y. The processing laser radiation and imaging light at least partially measure and weld while the battery cell is in the field of view Y of the beam delivery system(s) of the laser head while the cell is in motion. Again, this configuration is advantageous since the processing laser is engaged in actual welding activities for longer periods of time. In accordance with at least one embodiments, the laser head is configured to be stationary and the workpiece is configured to be in motion relative to the laser head during at least a portion of a time period where at least one of the processing laser radiation and the beam of imaging light are directed onto the workpiece.

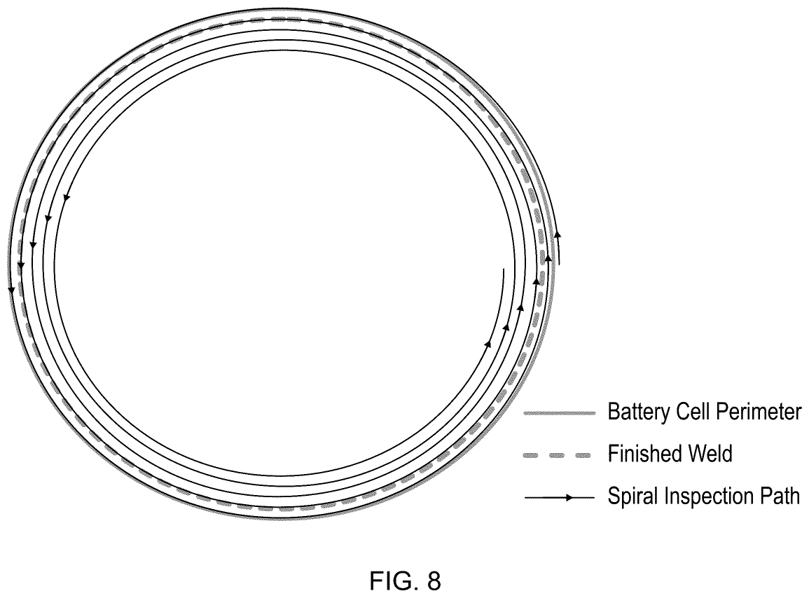

In some embodiments where the post-weld inspection scan is of circular, oval, or spiral geometry (as shown in FIG. 8), the geometry of the scan path, and the arrangement of the scans along that path can have multiple permutations which can be defined by the measurement system properties, weld system properties, and/or weld parameters. The geometry, such as the number of revolutions and spacing between subsequent revolutions of the scan, can be defined by and/or with respect to these properties, for example the process beam spot size and/or measurement beam spot size. The speed of the scan or sample rate of the measurements can be kept constant or changed to maintain a specific spacing between samples making up the measurement. Examples of this include defining the speed and/or sample rate to space the samples uniformly along the surface, space the samples constantly along the surface, or offset the samples with a specific pattern (such as where neighboring samples are offset diagonally with respect to each other, and/or modelled as a circle, oval, or other weaving pattern). This inspection scan can be used for the detection and measurement of, but not limited to, surface porosity, undercut, pinholes, and/or surface roughness, both along the center line of the weld, and/or away from the center line of the weld.

In some embodiments, a reference measurement can define the top surface of the component/feature being measured. Subsequent measurements performed can use this reference as a datum from which depth and/or height of a feature being measured can be defined. This reference can be defined by discrete measurements taken along the surface of the component/feature (taken before, during, or after the welding process), or through interpolation methods by taking a measurement at one or more points and interpolating between them. This method can use, but is not limited to, linear or cubic interpolation methods, and can be called a Virtual Reference Plane (VRP) if defined in this manner. In some embodiments, a weld depth is calculated in part by the system by using measurements taken by the imaging beam on the surface of the workpiece prior to welding. This may also be used to find a seam location.

In addition to the cap-to-can welds, according to some embodiments the system can be applied to measure and create paths for welding of any other battery features, such as the collector, tabs, or busbars. Fitting algorithms other than the direct linear least squares method could be used, and the fitted shape is not required to be a circle or ellipse.

Further, according to various embodiments the weld quality may be measured with the integrated OCT system, or monitored either independently, or in parallel with additional components added to the weld system such as photodiode sensors, acoustic sensors, and/or camera systems.

In accordance with at least one embodiment, the system can be configured to measure any optical path length variation caused by the optics by scanning to various locations in the work envelope on the workpiece. These measurements can then be used to apply corrections to distances measured by the OCT system, for example, by shifting the measured results digitally, by changing the geometry of the reference arm (e.g., adjusting the optical path length), or a combination of both.

In some configurations, the measurement spectral band (from the imaging beam) is different than the processing beam spectral band and chromatic aberrations induced by various optical components within the laser head cause the measurement spot to deviate from the focal position of the processing beam by different amounts for different positions within the scan field. Such deviation may be large enough to cause measurements to take place at incorrect positions relative to the phase change region or specific features on the workpiece. As such, chromatic aberration can cause problems for accurate process and/or imaging beam positioning on the workpiece, so according to some embodiments the process beam scanner (e.g., controller for the process beam scanner) may send current path positions of the process beam to the imaging beam scanner (e.g., controller of the imaging beam scanner), and the imaging beam scanner can then control the imaging beam to compensate for chromatic aberration. In other embodiments, corrections for chromatic aberration the process beam scanner may send corrections to the imaging beam scanner directly. In other embodiments, the imaging beam wavelength or band may be close enough to the process beam wavelength that correction for chromatic aberration is not required.

In some embodiments, machine learning techniques are used to train a model that is able to locate the geometry that is to be tracked. For example, the controller 150 may be configured to acquire a plurality of corrected weld paths (e.g., over time) and then process the plurality of corrected weld paths using one or more trained machine learning models to predict the corrected weld path. In some embodiments, the one or more trained machine learning models are further trained using the plurality of corrected weld paths. Machine learning may also be used in “master” tooling configurations that contain multiple locations for workpieces that are each measured and welded by the laser welding system. Each workpiece location within the tooling configuration may include specific corrections that, once learned, can be applied over and over by the controller for subsequent workpieces placed in these individual locations.

Machine learning may be further used by employing a cost function based on post-weld quality metrics obtained externally and/or by the OCT system itself to find the optimum parameters for seam offset, speed, wobble speed/amplitude/pattern, etc. For example, it may be determined that there exists a correlation between weld quality arising from proper placement of the weld seam and a certain detected acoustic signature. By varying the offset of the weld from the OCT-detected position of the material seam, studying the acoustic signature, and training a machine learning model on the basis of this acoustic signature, such a model may be used to inform how the OCT data and/or the subsequent fitting may be processed.

In some embodiments, spline interpolation (including cubic and higher order spline functions) is used instead of least-squares fitting of ellipses.

In some embodiments, a polar function that is the sum of multiple ellipses is used as the fitting function.

In some embodiments, the OCT system is a spectral domain type.

In some embodiments, the OCT system is a swept-source type.

### Working Example

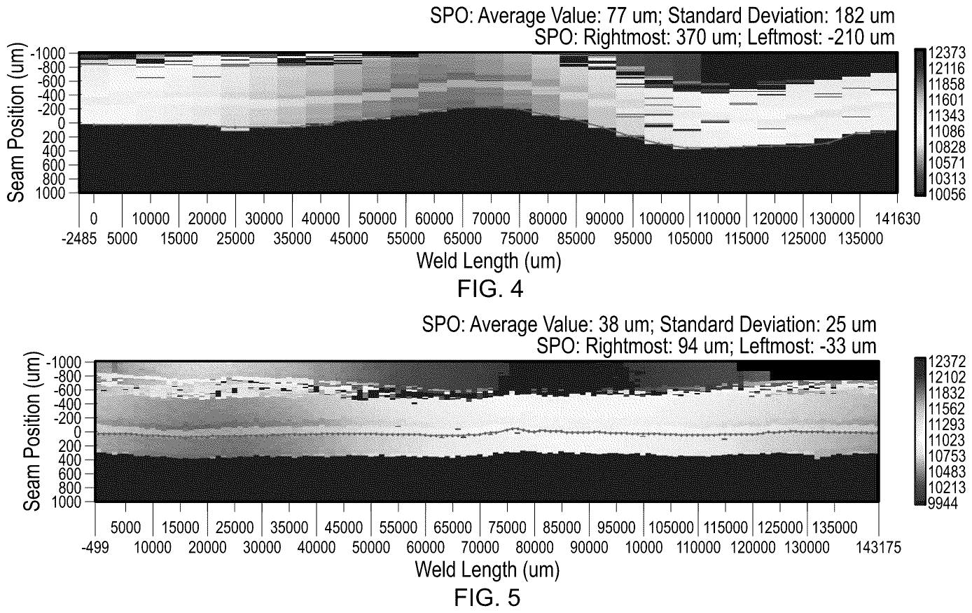

As a working example, a 4680 can/cap set was assembled by hand approximately under the center of an IPG Photonics 2D High Power Scanner connected to an IPG LDD-700 and YLS-6000/6000-50/150 AMB laser. The LDD system was previously aligned to the process beam using standard techniques, including some of those described in U.S. patent application Ser. No. 17/232,794 and owned by Applicant. The scanner was configured to weld a nominal circle of ~46 mm in diameter at 1 m/s with 300 W of incident laser power. The LDD system was configured to perform multiple scans substantially transverse to the welding path. While the scanner moved through its motion path with the laser emission inhibited, the transverse scans from the LDD system were analyzed by code running on the LDD PC to determine the location of the can edge within each scan. These locations were communicated via the LDD system's TCP direct data output to code running in the scanner's control software suite. Here, an ellipse was fit to the locations of the edges. The parameters of this elliptical fit were used to modify the scanner trajectory such that it more closely followed the edge. The LDD measurement was repeated with the correction active to show the improvement in the path's fidelity to the part geometry. FIGS. 4 and 5 show the LDD measurements before and then significantly improved after the correction, respectively. When the part is welded with the corrected path, a much better quality weld is produced.

Furthermore, FIG. 6 shows that after a weld is completed, the LDD system can detect surface pinholes. The left side of FIG. 6 shows OCT interferogram result data showing three (3) pinholes in a finished weld and the right side shows an overhead image of the detected pinholes.

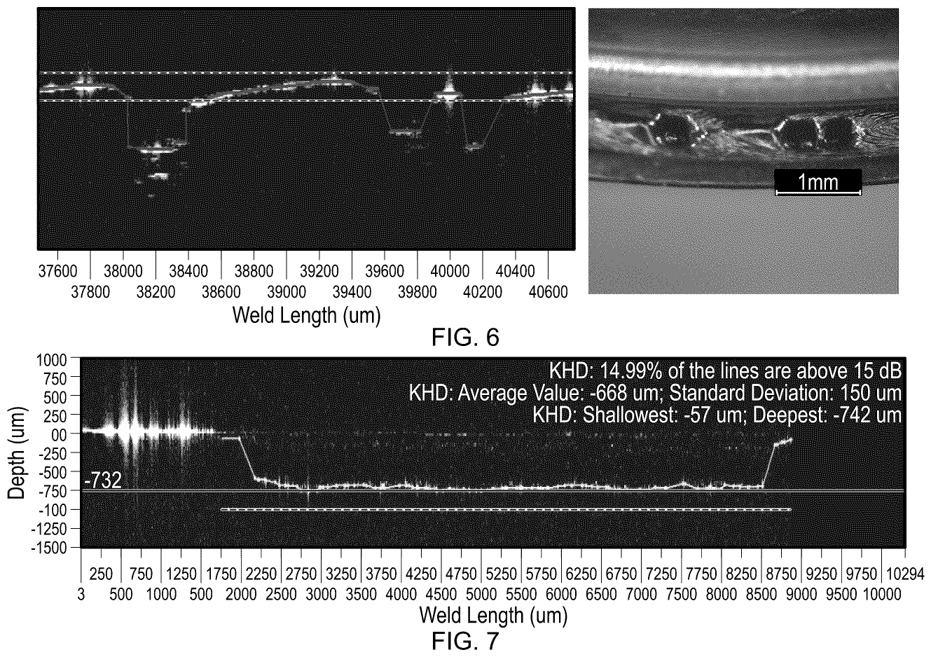

Also, FIG. 7 shows OCT interferogram result data that indicates that after initially welding the cap, the LDD system can measure the penetration depth of other welds through the can. This particular example shows a weld through the cap material into a material below the cap.

The aspects disclosed herein in accordance with the present invention, are not limited in their application to the details of construction and the arrangement of components set forth in the following description or illustrated in the accompanying drawings. These aspects are capable of assuming other embodiments and of being practiced or of being carried out in various ways. Examples of specific implementations are provided herein for illustrative purposes only and are not intended to be limiting. In particular, acts, components, elements, and features discussed in connection with any one or more embodiments are not intended to be excluded from a similar role in any other embodiments.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated reference is supplementary to that of this document; for irreconcilable inconsistencies, the term usage in this document controls. Moreover, titles or subtitles may be used in the specification for the convenience of a reader, which shall have no influence on the scope of the present invention.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. A laser welding system for welding a workpiece, comprising:
a laser source configured to emit processing laser radiation;
an optical coherence tomography (OCT) system that includes an imaging light source configured to emit imaging light, the OCT system configured to receive reflected imaging light from the workpiece and generate an interferometric output based at least in part on the reflected imaging light;
a laser head configured to direct processing laser radiation and a beam of the imaging light onto the workpiece;
at least one scanner configured to direct the beam of the imaging light along at least one measurement weld path on the workpiece, the at least one measurement weld path based at least in part on a reference weld path on the workpiece; and
at least one controller configured to:
receive data corresponding to the reference weld path on the workpiece;
generate a corrected weld path based at least in part on a comparison between the interferometric output of the at least one measurement weld path and the reference weld path; and
control the laser head such that the processing laser radiation is directed along the corrected weld path on the workpiece.

2. The laser welding system of claim 1, wherein the interferometric output of the at least one measurement weld path is used by the at least one controller to generate multi-dimensional geometric data that is used to generate the corrected weld path.

3. The laser welding system of claim 1, wherein the at least one controller is further configured to apply a curve fitting algorithm to generate the corrected weld path.

4. The laser welding system of claim 1, wherein the OCT system and a scanner of the at least one scanner are configured to obtain transverse measurements along the at least one measurement weld path.

5. The laser welding system of claim 1, wherein the reference weld path, measurement weld path, and corrected weld path are elliptical paths.

6. The laser welding system of claim 5, wherein the workpiece is a battery cell.

7. The laser welding system of claim 1, wherein the at least one controller controls the at least one scanner such that the beam of imaging light is directed along the corrected weld path at the same time as the processing laser radiation is directed along the corrected weld path, and the at least one controller is configured to calculate weld depth measurements based on an interferometric output generated at least in part from the beam of imaging light being directed along the corrected weld path.

8. The laser welding system of claim 7, wherein the at least one scanner includes a scanner configured to direct the processing laser radiation along the corrected weld path on the workpiece.

9. The laser welding system of claim 1, wherein the at least one controller controls the at least one scanner such that the beam of imaging light is directed along a post-weld scan path along the corrected weld path after the processing laser radiation is directed along the corrected weld path and the at least one controller is configured to calculate at least one post-weld measurement based on an interferometric output generated at least in part from the beam of imaging light being directed along the post-weld scan path.

10. The laser welding system of claim 1, wherein the controller is further configured to:
acquire a plurality of corrected weld paths; and
process the plurality of corrected weld paths using one or more trained machine learning models to predict the corrected weld path.

11. The laser welding system of claim 10, wherein the one or more trained machine learning models are further trained using the plurality of corrected weld paths.

12. The laser welding system of claim 1, wherein the laser head is configured to be stationary and the workpiece is configured to be in motion relative to the laser head during at least a portion of a time period where at least one of the processing laser radiation and the beam of imaging light are directed onto the workpiece.

13. A method for welding a workpiece, comprising:
receiving a reference weld path for the workpiece;
directing a beam of imaging light along at least one measurement weld path on the workpiece, the at least one measurement weld path based at least in part on the reference weld path;
determining interferometric output based at least in part on reflected imaging light from the workpiece along the at least one measurement weld path;
generating a corrected weld path based at least in part on a comparison between the interferometric output of the at least one measurement weld path and the reference weld path; and
directing processing laser radiation along the corrected weld path on the workpiece.

14. The method of claim 13, further comprising using the interferometric output of the at least one measurement weld path to generate multi-dimensional geometric data that is used to generate the corrected weld path.

15. The method of claim 13, wherein generating the corrected weld path further comprises applying a curve fitting algorithm.

16. The method of claim 13, further comprising obtaining transverse measurements with the beam of imaging light along the at least one measurement weld path.

17. The method of claim 13, further comprising:
directing the beam of imaging light along the corrected weld path while the processing laser radiation is directed along the corrected weld path;
determining interferometric output based at least in part on reflected imaging light from the workpiece along the corrected weld path; and
calculating weld depth measurements based on the interferometric output generated at least in part from the beam of imaging light being directed along the corrected weld path.

18. The method of claim 13, further comprising:
directing the beam of imaging light along a post-weld scan path after the processing laser radiation is directed along the corrected weld path;
determining interferometric output based at least in part on reflected imaging light from the workpiece along the post-weld scan path; and
calculating at least one post-weld measurement based on the interferometric output generated at least in part from the beam of imaging light being directed along the post-weld scan path.

19. The method of claim 13, wherein the reference weld path, measurement weld path, and corrected weld path are elliptical paths.

20. The method of claim 19, wherein the workpiece is a battery cell and the method further comprises:
comparing geometric coordinate values of the corrected weld path to a target threshold; and
in response to a determination that the geometric coordinate values fall within the target threshold, accepting the battery cell, or
in response to a determination that the geometric coordinate values do not fall within the target threshold, rejecting the battery cell.

21. The method of claim 13, further comprising:
acquiring a plurality of corrected weld paths; and
processing by a computer processor the plurality of corrected weld paths using one or more trained machine learning models to predict the corrected weld path.

22. The method of claim 21, further comprising training the one or more trained machine learning models using the plurality of corrected weld paths.
